(19) United States
(12) Patent Application Publication
(10) Pub. No.: US 2008/0196288 A1
(43) Pub. Date: Aug. 21, 2008

(54) PRINTED FLEXIBLE MAGNET

(76) Inventor: Dan Turner, West Palm Beach, FL (US)

Correspondence Address: CONNOLLY BOVE LODGE & HUTZ LLP, 1875 EYE STREET, N.W., SUITE 1100, WASHINGTON, DC, 20036, US

(21) Appl. No.: 11/676,122

(22) Filed: Feb. 16, 2007

(51) Int. Cl. G09F 7/04

(52) U.S. Cl. 40/600

(57) ABSTRACT

A printed flexible magnet constructed of a flexible magnetic sheet of material includes a first portion and a second portion that are divided from each other by a primary line of weakness. The first portion may include one or more printed advertisements on its front and/or back surface, and may be separated from the first portion at the line of weakness. The second portion may include printed coupon on its front and/or back surface. According to another embodiment the second portion may be divided into a plurality of segments by secondary lines of weakness. According to such an embodiment, the segments may be detached from each other at the secondary lines of weakness and may be detached from the first portion at the primary line of weakness. The magnetic sheet may be have any of a variety of shapes, such as circular, rectangular or triangular, and the first portion, second portion and segments may have a variety of complimentary shapes within the magnetic sheet.

### BACKGROUND

It is known to use magnetic elements for decorative purposes and to display advertising information. However, it is desirable to provide improved magnetic elements for displaying information such as advertising and coupon information, wherein the magnetic elements have improved functionality and are easy and cost-efficient to manufacture.

### SUMMARY

The invention relates to a flexible magnet assembly incorporating advertising and at least one removable coupon card portion. According to one embodiment, a thin, flexible, magnet assembly comprises a single-layer flexible magnetic sheet having opposite faces and including:

a first magnetic portion including at least one advertisement on at least one face of said opposite faces;

a second magnetic portion including coupon information on said at least one face; and

a line of weakness distinguishing said first magnetic portion from said second magnetic portion, wherein said first magnetic portion and said second magnetic portion are separable from each other along said line of weakness.

According to another embodiment, a flexible magnet comprises a single-layer flexible magnetic sheet having opposite faces and including:

a first magnetic portion adapted to receive at least one advertisement on at least one face of said opposite faces;

a second magnetic portion comprising a plurality of magnetic segments, wherein each of said magnetic segments is adapted to receive coupon information on said at least one face;

a primary line of weakness distinguishing said first magnetic portion from said second magnetic portion; and

secondary lines of weakness distinguishing adjacent segments of said magnetic segments from each other wherein said adjacent segments are separable from each other along one of said secondary lines of weakness, and wherein each of said magnetic segments is separable from said first magnetic portion along said primary line of weakness.

According to a further embodiment, a single-layer, flexible, magnetic coupon sheet having opposite faces comprises:

an advertising portion including at least one advertisement on at least one face thereof;

a coupon portion including coupon information on at least one face thereof; and

a line of weakness distinguishing said advertising portion from said coupon portion, wherein said advertising portion and said coupon portion are separable from each other along said line of weakness.

According to yet another embodiment, a single-layer, flexible, magnetic coupon sheet having first and second opposite faces comprises:

an advertising portion including at least one advertisement printed on at least said first face;

a coupon portion comprising a plurality of coupon segments, wherein each of said segments includes coupon information on at least said first face;

a primary line of weakness distinguishing said advertising portion from said coupon portion; and

secondary lines of weakness distinguishing adjacent segments of said plurality of coupon segments from each other, wherein said adjacent segments are separable from each other along one of said secondary lines of weakness, and wherein each of said coupon segments is separable from said advertising portion along said primary line of weakness.

Other features and advantages will become apparent from the following detailed description and drawings.

### BRIEF DESCRIPTION OF THE DRAWINGS

FIG. 1A is a front view of a circular flexible magnet according to one embodiment, including a first, advertising portion and a second, coupon portion that is detachable from the advertising portion.

FIG. 1B shows the magnet of FIG. 1A with the coupon portion detached.

FIG. 1C is a rear view of the magnet of FIGS. 1A and 1B.

FIG. 2A is a front view of a flexible magnet according to another embodiment, wherein the coupon portion is divided into a plurality of detachable coupon segments.

FIG. 2B shows the magnet of FIG. 2A with coupon segments removed.

FIG. 3 is a front view of a rectangular flexible magnet according to another embodiment.

FIG. 4 is a front view of a rectangular flexible magnet, wherein the coupon portion is divided into a plurality of rectangular coupon segments.

FIG. 5 is a front view of a flexible magnet according to another embodiment, wherein the flexible magnet has a triangular shape.

FIG. 6 is a front view of a triangular flexible magnet according to yet another embodiment, wherein the coupon portion is divided into a plurality of quadrilateral coupon segments.

FIG. 7 is a front view of a triangular flexible magnet according to yet another embodiments wherein the coupon portion is divided into a plurality of triangular coupon segments.

### DETAILED DESCRIPTION

Various embodiments of flexible magnets are disclosed in the following paragraphs. The disclosed magnets are ideal for use as advertising and coupon cards, however other uses are envisioned. With regard to the description and drawing figures that follow, reference characters repeated throughout various embodiments indicate similar elements or features.

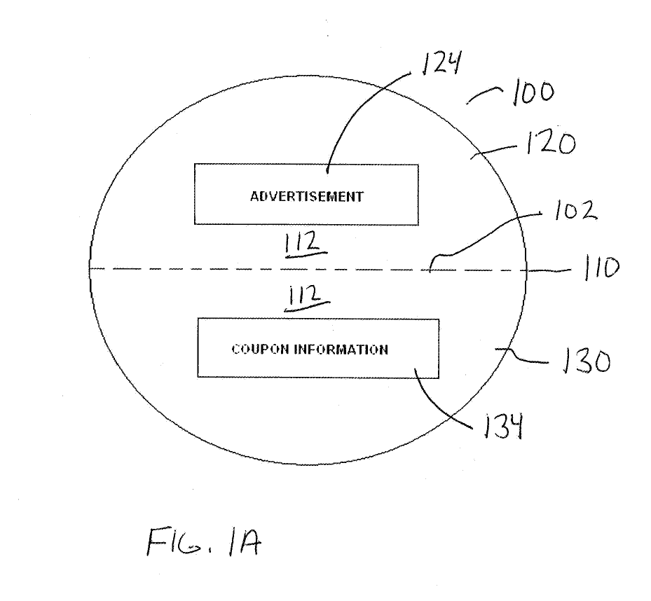

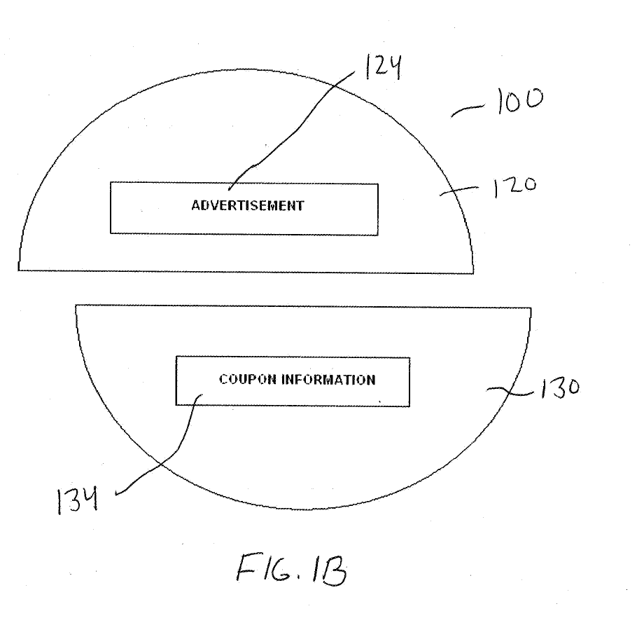

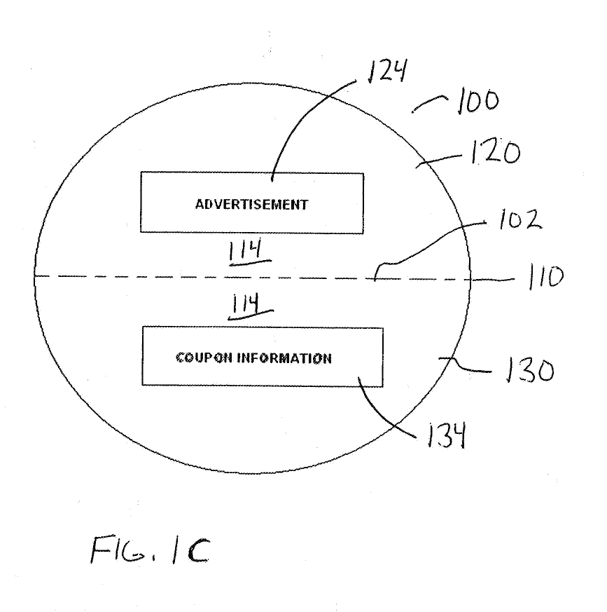

FIG. 1A shows a thin, flexible magnet 100. The magnet 100 includes a single-layer, flexible magnetic sheet 110 that is divided into a first magnetic portion 120 and a second magnetic portion 130 by a line of weakness 102. The line of weakness 102 may be formed from a score line or a line of perforations extending substantially through the thickness of the magnetic sheet 110.

The first magnetic portion 120 may include one or more printed advertisements 124, which may be in the form of text and, optionally, decorative graphics, printed directly on the front face 112 of the magnetic sheet 110. The second magnetic portion 130 may include printed coupon information 134, which may include text and, optionally, decorative graphics printed directly on the front face 112 of the magnetic sheet 110.

As shown in FIG. 1B, the second magnetic portion 130 may be detached from the first magnetic portion 120 at the line of weakness 102 by a user simply pulling the portions 120 and 130 apart along the line of weakness 102. Thus, the first portion 120 may be retained on a magnetically attractive surface such as a refrigerator or display board (not shown), while the second portion 130 may be detached and presented for coupon redemption upon the purchase of good(s) or service(s).

Referring to FIG. 1C, the sheet 110 includes a rear face 114 which has the same shape as the front face 112. The rear face 114 may also include one or more printed advertisements 124 and printed coupon information 134, if desired. In the embodiment of FIGS. 1A-1B, the faces 112 and 114 of the magnetic sheet 110 are circular in shape and the first and second portions 120, 130 each have a semicircular shape in the planes of the front and back faces 112 and 114. However, the shapes depicted in these drawings are for illustrative purposes. Other shapes may be used as desired without departing from the scope of this invention.

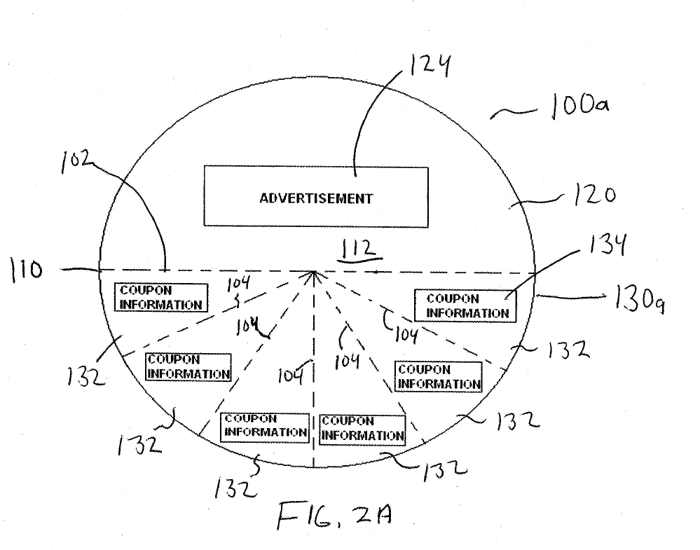

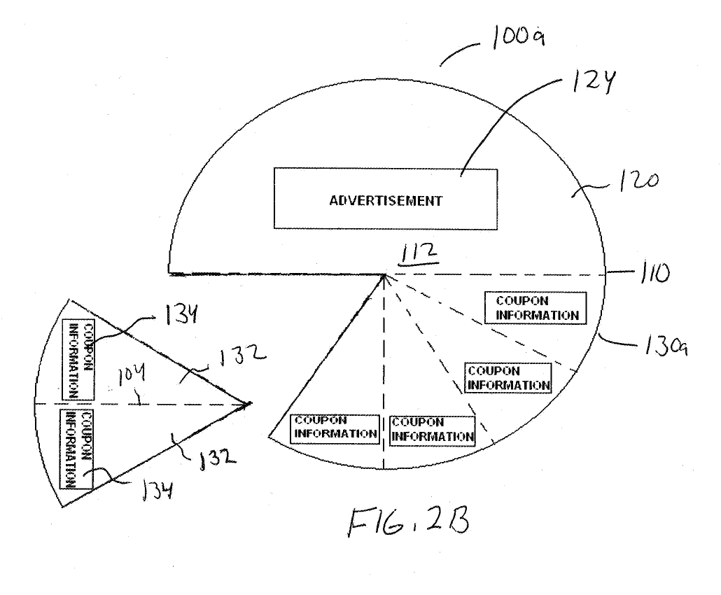

FIGS. 2A-2B show a flexible magnet 100a according to another embodiment. With reference to FIG. 2A, the magnet 100a is similar to magnet 100 of the previous embodiment, except that the line of weakness 102 forms a primary line of weakness between the first magnetic portion 120 and the second magnetic portion 130a, and the second magnetic portion 130a is divided into a plurality of segments 132 by secondary lines of weakness 104 which intersect the primary line of weakness 102. The secondary lines of weakness 104, like the primary line of weakness 102, may be formed from score lines or lines of perforations extending substantially through the thickness of the magnetic sheet 110. The segments 132 are shown as pie-shaped wedges, however, other shapes are possible.

Each of the segments 132 may include printed coupon information 134, which may include text and, optionally, graphics printed directly on the front face 112 of the magnetic sheet 110. Thus, each segment 132 may form a unique coupon and/or a duplicate coupon, as desired. As in the previous embodiment, the coupon information 134 and advertisement(s) 124 may also appear on the rear face (not shown) of the magnetic sheet 110.

As shown in FIG. 2B, each segments 132 may be detached from the first magnetic portion 120 at the primary line of weakness 102 by a user simply pulling cutting or tearing the first magnetic portion 120 and the segment 132 apart along the primary line of weakness 102. Adjacent segments 132 may be detached each other by a user simply pulling, cutting or tearing adjacent segments 132 apart along a secondary line of weakness 104. Thus, the first magnetic portion 120 may be retained on a magnetically attractive surface such as a refrigerator or display board (not shown), while each segment 132 may be individually detached from the first magnetic portion 120 and the remaining segments 132, and presented for coupon redemption upon the purchase of good(s) or service(s). Alternatively, one or more segments 132 may be detached from the sheet 110 as a group.

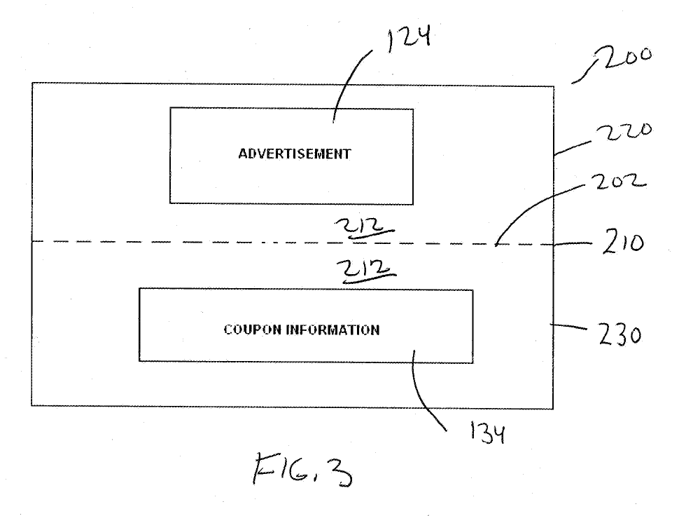

FIGS. 3-7 show alternative embodiments in which the magnetic sheet, first magnetic portion and second magnetic portion have various shapes and configurations. The magnets described below are of the same construction and functionality described in the preceding embodiments, with the only differences being the shape and configuration of the first magnetic portion and second magnetic portion. These exemplary embodiments, and the embodiments of FIGS. 1A-2B described above, are not intended to be limiting as to the types and combination of shapes that are possible, but are merely intended to provide a few examples of the many shapes and configurations that are possible.

FIG. 3 shows a flexible magnet 200 including a single-layer, flexible magnetic sheet 210 that is divided into a first magnetic portion 220 and a second magnetic portion 230 by a line of weakness 202. The first magnetic portion 220 bears one or more advertisements 124, while the second magnetic portion bears coupon information 134. As illustrated in FIG. 3, the front face 212 and back face (not shown) of the magnetic sheet 210 are rectangular in shape and the first and second portions 220, 230 each have a rectangular shape in the planes of the front and back faces. The back face of the sheet may, if desired, include one or more advertisements and coupon information, in the same fashion as the front face 212.

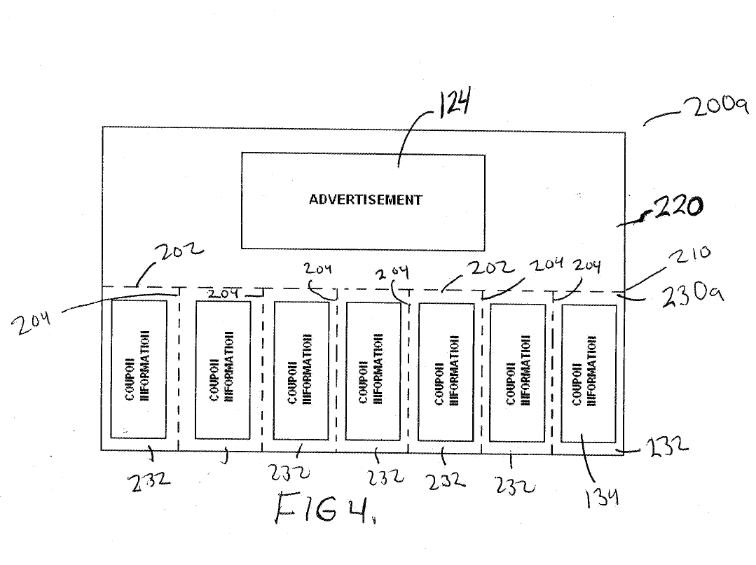

FIG. 4 shows a flexible magnet 200a which is similar to magnet 200 of the embodiment of FIG. 3, except that the line of weakness 202 forms a primary line of weakness between the first magnetic portion 220 and the second magnetic portion 230a, and the second magnetic portion 230a is divided into a plurality of segments 232 by secondary lines of weakness 204 which intersect the primary line of weakness 202. Each of the segments 232 bears coupon information 134. The segments 232 are shown having a rectangular shape in the planes of the front face 212 and back face (not shown), although other shapes may be used.

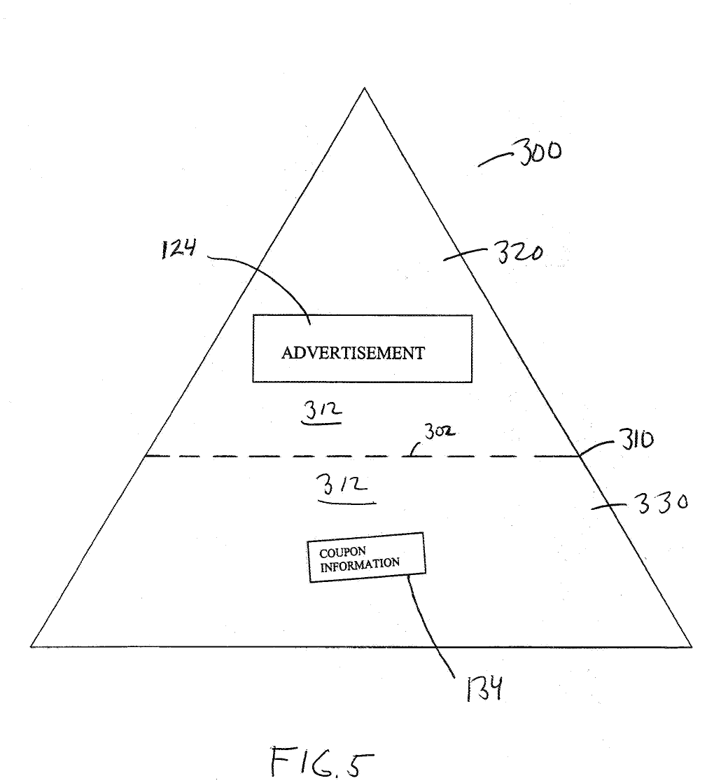

FIG. 5 shows a flexible magnet 300 including a single-layer, flexible magnetic sheet 310 that is divided into a first magnetic portion 320 and a second magnetic portion 330 by a line of weakness 302. The first magnetic portion 320 bears one or more advertisements 124, while the second magnetic portion bears coupon information 134. The front face 312 and back face (not shown) of the magnetic sheet 310 are triangular in shape and the first and second portions 320, 330 each have a rectangular shape in the planes of the front and back faces. As in the other embodiments described herein, the back face of the sheet may, if desired, include one or more advertisements and coupon information, in the same fashion as the front face 312.

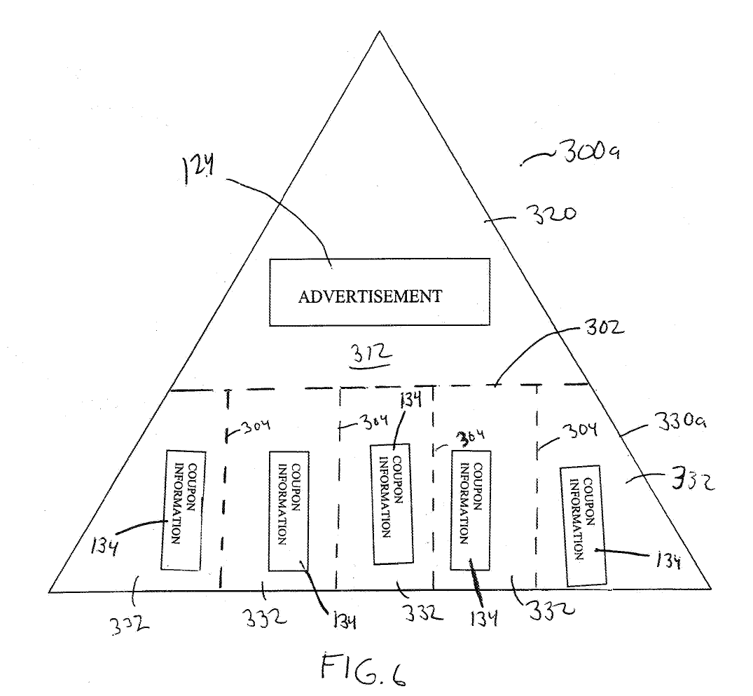

FIG. 6 shows a flexible magnet 300a which is similar to magnet 300 of the embodiment of FIG. 5, except that the line of weakness 302 forms a primary line of weakness between the first magnetic portion 320 and the second magnetic portion 330a, and the second magnetic portion 330a is divided into a plurality of segments 332 by secondary lines of weakness 304 which intersect the primary line of weakness 302. Each of the segments 232 bears coupon information 134. The segments 332 are shown having various quadrilateral shapes in the planes of the front face 312 and back face (not shown), although other shapes may be used.

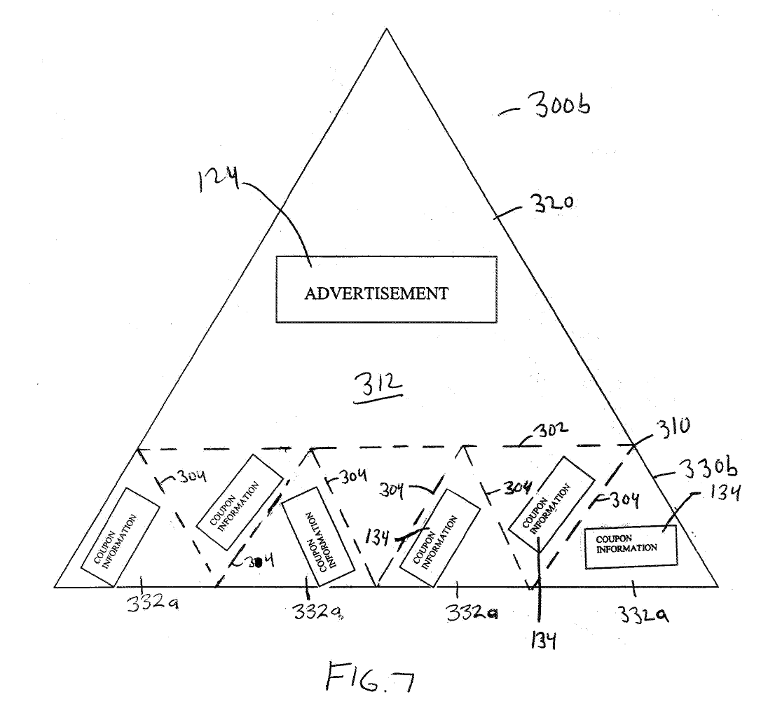

FIG. 7 shows another embodiment in which magnet 300b is a variation of the magnet 300a. Magnet 300b is similar to magnet 300a, except that magnet 300b includes a second magnetic portion 330b which is divided into segments 332a having a triangular shape in the planes of the front face 312 and back face (not shown).

The above embodiments describe thin, flexible magnets including a single-layer, flexible magnetic sheet having advertising and coupon information printed directly on the magnetic sheet. However, flexible magnets according to additional embodiments of the invention may include a flexible magnetic sheet without any printed coupon or advertising information and an additional, thin, sheet of material attached to one or both of the surfaces of the magnetic sheet. The additional sheet of material may be attached to the underlying magnetic sheet with an adhesive and may be scored or perforated in the same fashion as the magnetic sheet so as to form part of the advertising portion, coupon portion, and, optionally, multiple coupon segments. A few examples of materials that are suitable for use as such an additional sheet of material are paper, laminated paper and thin plastic.

The flexible magnetic material of this invention may be of any conventional composition. Such material typically comprises a dispersion of magnetizable particles in a natural or synthetic resin binder. The magnetic material is commonly manufactured by dispersing the magnetic particles in an uncured or unhardened state of the resin binder, then forming the mixture into a sheet, or other appropriate shape for magnetic article, and curing or hardening the binder. For example, the magnetic particles may be dispersed in an uncured rubber or plasticized resin in a high-shear mixer, and the mixture may then be extruded, usually at elevated temperature, through a suitably shaped die or nozzle to form a sheet material. The sheet may be used as extruded, i.e., uncured, or may be cured by incorporating a curing or vulcanizing agent into the mixture or by cooling to about room temperature. When prepared by extrusion, calendering or the like, the magnetic layer may have a thickness, for example, of from about 0.01 inch to about 1 inch (about 250 micrometers to about 2.54 centimeters). It is also possible to prepare the magnetic layer by forming a dispersion of a particulate magnetic material and a resin binder therefore in a volatile vehicle. The dispersion may then be coated onto a flexible substrate to a desired thickness, and the volatile vehicle evaporated leaving a layer comprising the particulate magnetic material dispersed in the resin binder. After formation of the layer of magnetic particles in a resin binder, the layer is magnetized by conventional procedures, e.g., by passing the layer over a multipole magnetizer. The magnetic layer will typically comprise from about 40% about 92% by weight of a magnetizable particulate material and about 8% to about 60% of a binder.

When the magnetic layer is prepared by coating from a volatile solvent solution or dispersion, the layer is generally relatively thin, i.e., to provide a dried solid layer of magnetic material of a thickness ranging from about 1 mil (25 μm) to about 120 mil (3 mm), preferably from about 1 mil (25 μm) to bout 20 mils (500 μm), and more preferably from about 5 mils (125 μm) to about 20 mils (500 μm).

If the magnetic layer is prepared by coating a dispersion of magnetic particles and resin binder in a volatile solvent, any conventional coating procedure can be used to deposit the coating dispersion onto the substrate. Thus, roll coating, gravure coating, doctor blade coating, extrusion, and the like can be used to deposit the dispersion or slurry onto the substrate. A preferred method of coating is to deposit the slurry onto a web substrate and immediately pass the coated substrate over a roll having a doctor blade spaced from the roll to control the thickness of the deposit. The dispersion of magnetic particles and binder can also be deposited onto the substrate by printing. The magnetic layer need not be continuous on the substrate, but can be deposited in a pattern, e.g., dots of magnetic material distributed over the substrate.

The substrate may be a preprinted paper or plastic web provided with text, photographs, or decorative artwork or may be a thin web to which a printed paper or plastic web is fastened with adhesive. The substrate may be have a release surface, e.g., a glass surface or synthetic resin web treated with a release agent, e.g., a silicone material, to prevent the binder from forming a permanent bond with the substrate. After the magnetic layer has dried, it can be transferred to another surface either directly or after being stripped from the release layer. If the binder of the magnetic layer is a pressure-sensitive binder the magnetic layer can be directly adhered to another surface by pressure. The magnetic layer may also be softened by contact with a solvent for the binder and transferred by pressure to another surface. The separately prepared magnetic layer can also be adhered to another surface by an intermediate layer of adhesive. The substrate for such solvent coated magnetic layers and high-permeability layers will typically be a thin and often flexible web material, suitable for providing a surface that can carry printing or the like. Such substrate should be a lightweight material preferably having a weight not exceeding about 10 pounds per square foot (4.88 g/cm²). The substrate for use with magnetic layers prepared by extrusion of a mixture of magnetic particles in a binder may be significantly heavier if necessary, i.e., having a weight of Up to several tens of pounds per square foot.

The particulate magnetic material used in the magnetic layer of the invention may be any material that can be incorporated into magnetic coating in sufficient amount and permanently magnetized to a sufficient magnetic strength to achieve a magnetic layer that is self-adherent to a magnetic attractant surface. Suitable particulate magnetic materials include any magnetizable magnetic particles conventionally used in flexible magnetic layers. Accordingly, magnetic particles having a high magnetization and high coereivity, such as strontium and barium ferrites, alloys with a base of aluminum, nickel, and cobalt (ALNICO), rare earth magnetic materials, such as those incorporating neodymium, iron, boron and the like, can be used. It is preferred to use particles of strontium ferrite.

Suitable extrudable resin binders include natural and synthetic rubbers poly(vinyl chloride), plastisols e.g., poly(vinyl chloride) plastisols, polyethylene, chlorinated polyethylene, chlorosulfonated polyethylene, polypropylene, polyisobutylene, styrene-butadiene resins, and mixtures thereof, and the like. Suitable coatable resin binders include any natural or synthetic resin that is dispersible in a volatile liquid vehicle used in the process of the invention. Preferred binders include synthetic water-dispersible resins such as vinyl acetate, copolymers of vinyl chloride and vinyl acetate, ethylene-vinyl acetate copolymers, polyvinyl butyral, styrene-maleic acid resins and modified styrenemaleic acid resins, acrylic latices such as ethyl acrylate or acrylate-methacrylate copolymer lattices, polyolefins, and the like. Resins soluble in volatile organic solvents can also be used in the process of the invention, although they are less preferred because volatile organic solvents are subject to significant environmental restrictions.

Alternatively, the magnetic material of this invention may be prepared according to the disclosures of U.S. Pat. Nos. 5,869,148 and 7,128,798, the specifications of which are incorporated herein by reference.

The inventive concept having now been described in various embodiments, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalency of the claims are intended to be embraced therein.

I claim:

1. A flexible magnet assembly comprising a single-layer flexible magnetic sheet having opposite faces, said magnetic sheet comprising:
a first magnetic portion including at least one advertisement on at least one face of said opposite faces;
a second magnetic portion including coupon information on said at least one face; and
a line of weakness distinguishing said first magnetic portion from said second magnetic portion, wherein said first magnetic portion and said second magnetic portion are separable from each other along said line of weakness.

2. The flexible magnet assembly of claim 1, wherein said line of weakness is formed by a score line or a perforated line in said magnetic sheet.

3. A flexible magnet comprising a single-layer flexible magnetic sheet having opposite faces, said magnetic sheet comprising:
a first magnetic portion adapted to receive at least one advertisement on at least one face of said opposite faces;
a second magnetic portion comprising a plurality of magnetic segments wherein each of said magnetic segments is adapted to receive coupon information on said at least one face;
a primary line of weakness distinguishing said first magnetic portion from said second magnetic portion; and
secondary lines of weakness distinguishing adjacent segments of said magnetic segments from each other, wherein said adjacent segments are separable from each other along one of said secondary lines of weakness, and wherein each of said magnetic segments is separable from said first magnetic portion along said primary line of weakness.

4. The flexible magnet of claim 4, wherein said primary line of weakness and said secondary lines of weakness are formed by score lines or perforated lines in said magnetic sheet.

5. A single-layer, flexible, magnetic coupon sheet having opposite faces, said magnetic coupon sheet comprising:
an advertising portion including at least one advertisement on at least one face among said opposite faces;
a coupon portion including coupon information on said at least one face; and
a line of weakness distinguishing said advertising portion from said coupon portion, wherein said advertising portion and said coupon portion are separable from each other along said line of weakness.

6. A single-layer, flexible, magnetic coupon sheet having opposite first and second faces, said magnetic coupon sheet comprising:
an advertising portion including at least one advertisement on at least said first face;
a coupon portion comprising a plurality of coupon segments, wherein each of said coupon segments includes coupon information on at least said first face;
a primary line of weakness distinguishing said advertising portion from said coupon portion; and
secondary lines of weakness distinguishing adjacent segments among said coupon segments from each other, wherein said adjacent segments are separable from each other along one of said secondary lines of weakness, and wherein each of said coupon segments is separable from said advertising portion along said primary line of weakness.

7. A flexible magnet assembly comprising:
a thin magnetic sheet having opposite faces;
at least one sheet of material attached to at least one face of said opposite faces; and
a first line of weakness extending through said at least one sheet of material and said magnetic sheet, said line of weakness defining a first magnet portion including advertising information printed on said at least one sheet of material and a second magnet portion including coupon information printed on said at least one sheet of material, wherein said first magnet portion and said second magnet portion are separable from each other along said line of weakness.

8. The flexible magnet assembly of claim 9, comprising additional lines of weakness extending through said at least one sheet of material and said magnetic sheet in said second magnet portion, said additional lines of weakness defining coupon segments, wherein adjacent segments of said coupon segments are separable from each other along said additional lines of weakness, and wherein said coupon segments are separable from said advertising portion along said first line of weakness.

9. The flexible magnet assembly of claim 9, wherein said first line of weakness is formed by a score line or a perforated line.

10. The flexible magnet assembly of claim 10, wherein said additional lines of weakness are formed by score lines or perforated lines.
